(19) United States
(12) Patent Application Publication
(10) Pub. No.: US 2006/0221643 A1
(43) Pub. Date: Oct. 5, 2006

(54) Light generating unit, method of manufacturing the same, backlight assembly having the same display device having the same

(75) Inventors: Hae-Il Park, Seoul (KR); Sang-Yu Lee, Yongin-si (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd.

(21) Appl. No.: 11/223,586

(22) Filed: Sep. 8, 2005

(30) Foreign Application Priority Data
Apr. 4, 2005 (KR) 2005-28098

(51) Int. Cl. F21V 7/04

(52) U.S. Cl. 362/632

(57) ABSTRACT

A light generating unit that includes a lamp body and an external electrode. The lamp body includes a discharge space to generate a light. The external electrode includes a metal layer and a protection layer that covers the metal layer. The external electrode is positioned on the lamp body to apply a discharge voltage to the lamp body.

### CROSS-REFERENCE TO RELATED APPLICATION

The present application claims priority from Korean Patent Application No. 2005-28098, filed on Apr. 4, 2005, the disclosure of which is hereby incorporated herein by reference in its entirety.

### BACKGROUND OF THE INVENTION

1. Field of the Invention

The present invention relates to a light generating unit, a method of manufacturing the light generating unit, a backlight assembly having the light generating unit and a display device having the light generating unit. More particularly, the present invention relates to a light generating unit capable of generating a light of a uniform luminance, a method of manufacturing the light generating unit, a backlight assembly having the light generating unit and a display device having the light generating unit.

2. Description of the Related Art

A liquid crystal display (LCD) device, in general, displays an image using a liquid crystal. The LCD device has various characteristics such as thin thickness, light weight, low driving voltage, low power consumption, etc. Therefore, the LCD device is frequently used.

An LCD device is a non-emissive type display device which requires a light source.

An LCD device may include a cold cathode fluorescent lamp (CCFL) having an extended cylindrical shape. A large-screen LCD device typically includes a plurality of the CCFLs. When the number of the CCFLs is increased, a manufacturing cost of the LCD device is increased, and luminance uniformity and optical characteristics of the LCD device deteriorate.

In order to improve the luminance uniformity and the optical characteristics of an LCD device, a flat fluorescent lamp has been developed. The flat fluorescent lamp includes a lamp body and an electrode. The lamp body includes an internal space that is divided into a plurality of discharge spaces. The electrode which is located on an exterior surface of the lamp body is used to apply a discharge voltage to the discharge spaces through the electrode. When the discharge voltage is applied to the discharge spaces, a plasma discharge is generated in the discharge spaces which generates an ultraviolet light. When the ultraviolet light is irradiated onto a fluorescent layer, excitons are formed in the fluorescent layer. A visible light is generated by the excitons.

The electrode is electrically insulated from the receiving container. When the discharge voltage is applied to the electrode, a metal of the electrode is oxidized, and ozone is generated. This results in deterioration of the electrode.

### SUMMARY OF THE INVENTION

The present invention provides a light generating unit capable of generating a light of a uniform luminance.

The present invention also provides a method of manufacturing the above-mentioned light generating unit.

The present invention also provides a backlight assembly having the above-mentioned light generating unit.

The present invention also provides a display device having the above-mentioned light generating unit.

A light generating unit in accordance with an exemplary embodiment of the present invention includes a lamp body and an external electrode. The lamp body includes a discharge space to generate a light. The external electrode includes a metal layer and a protection layer that covers the metal layer. The external electrode is on the lamp body to apply a discharge voltage to the lamp body.

A method of manufacturing a light generating unit in accordance with an exemplary embodiment of the present invention is provided as follows. A conductive member having a metal layer and a protection layer on the metal layer is prepared. The conductive member is combined with a lamp body that has a discharge space to generate a light.

A backlight assembly in accordance with an exemplary embodiment of the present invention includes a light generating unit, an optical member and a receiving container. The light generating unit includes a lamp body and an external electrode. The lamp body includes a discharge space to generate a light. The external electrode includes a metal layer and a protection layer that covers the metal layer. The external electrode is on the lamp body to apply a discharge voltage to the lamp body. The optical member improves optical characteristics of the light generated from the light generating unit. The receiving container receives the light generating unit and the optical member.

A display device in accordance with an exemplary embodiment of the present invention includes a light generating unit, an optical member, a receiving container and a display unit. The light generating unit includes a lamp body and an external electrode. The lamp body includes a discharge space to generate a light. The external electrode includes a metal layer and a protection layer that covers the metal layer. The external electrode is on the lamp body to apply a discharge voltage to the lamp body. The optical member improves optical characteristics of the light generated from the light generating unit. The receiving container receives the light generating unit and the optical member. The display unit displays an image using the light that has passed through the optical member.

According to the present invention, the protection layer protects the external electrode to prevent an oxidation of the external electrode. In addition, the external electrode is electrically insulated from adjacent conductive element. Therefore, a light luminance of the light generating unit is increased.

### BRIEF DESCRIPTION OF THE DRAWINGS

The above and other advantages of the present invention will become more apparent in light of the detailed exemplary embodiments disclosed below along with reference to the accompanying drawings, in which:

FIG. 1 is a cross-sectional view showing a light generating unit in accordance with an exemplary embodiment of the present invention;

FIG. 2 is a cross-sectional view showing a light generating unit in accordance with another exemplary embodiment of the present invention;

FIG. 3 is an exploded perspective view showing a light generating unit in accordance with another exemplary embodiment of the present invention;

FIG. 4 is a cross-sectional view taken along a line 4-4 shown in FIG. 3 with the structure as assembled;

FIG. 5 is an exploded perspective view showing a light generating unit in accordance with another exemplary embodiment of the present invention;

FIG. 6 is a cross-sectional view taken along a line 6-6 shown in FIG. 5 with the structure assembled;

FIG. 7 is a flow chart showing a method of manufacturing a light generating unit in accordance with an exemplary embodiment of the present invention;

FIG. 8 is an exploded perspective view showing a backlight assembly in accordance with an exemplary embodiment of the present invention;

FIG. 9 is a cross-sectional view taken along line 9-9 of FIG. 8 showing the backlight assembly shown in FIG. 8 in an assembled state;

FIG. 10 is an exploded perspective view showing a display device in accordance with an exemplary embodiment of the present invention; and

FIG. 11 is a cross-sectional view taken along line 11-11 of FIG. 10 showing the display device shown in FIG. 10 in an assembled state.

### DESCRIPTION OF THE EMBODIMENTS

It should be understood that the exemplary embodiments of the present invention described below may be varied modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

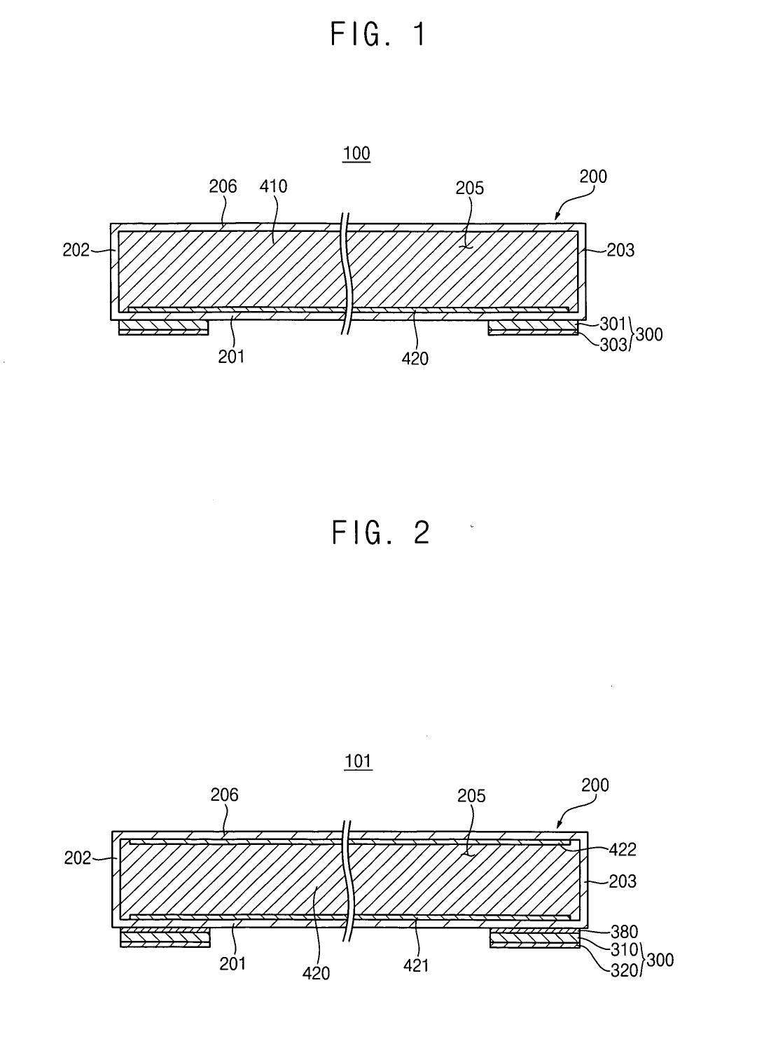

FIG. 1 is a cross-sectional view showing a light generating unit in accordance with an exemplary embodiment of the present invention.

Referring to FIG. 1, the light generating unit 100 includes a lamp body 200 and an external electrode 300.

The lamp body 200 has a flat shape. Light is generated in an internal space of the lamp body 200. The lamp body 200 includes a transparent insulating material. Examples of the transparent insulating material that is used for the lamp body 200 include a glass, polycarbonate, etc.

The lamp body 200 includes a bottom portion 201, a plurality of side portions 202 and 203 and a light emitting portion 206.

In this exemplary embodiment, the bottom portion 201 has a quadrangular plate shape.

The side portions 202 and 203 extend from sides of bottom portion 201, and are similarly shaped. In this exemplary embodiment, the side portions 202 and 203 have a substantially same material as the bottom portion 201 or the light emitting portion 206.

The light emitting portion 206 is on the side portions 202 and 203 corresponding to the bottom portion 201. In this exemplary embodiment, the light emitting portion 206 has substantially same material and shape as the bottom portion 201.

The bottom portion 201, the light emitting portion 206 and the side portions 202 and 203 form a discharge space 205.

The lamp body 200 further includes a discharge gas 410 and a fluorescent layer 420. The fluorescent layer 420 changes invisible light generated by the discharge gas 410 into a visible light.

The discharge gas 410 is enclosed in the discharge space 205 of the lamp body 200. When plasma is generated in the discharge space 205, invisible light is generated from the discharge gas 410. In this exemplary embodiment, the invisible light is an ultraviolet light.

Examples of the discharge gas 410 include mercury gas, argon gas, neon gas, xenon gas, krypton gas, etc. These can be used alone or in a combination thereof.

The fluorescent layer 420 is positioned on an interior surface of the lamp body 200. In this exemplary embodiment, the fluorescent layer 420 is on the bottom portion 201.

Alternatively, the fluorescent layer 420 may be positioned on the bottom portion 201 and on the light emitting portion 206. The fluorescent layer 420 changes the invisible light into the visible light. In this exemplary embodiment, the visible is a white light.

In this exemplary embodiment, the fluorescent layer 420 includes a red fluorescent material, a green fluorescent material and a blue fluorescent material. A red light, a green light and a blue light are generated by the red, green and blue fluorescent materials, respectively. In this exemplary embodiment, amount of the red, green and blue lights are substantially same. The red, green and blue lights are mixed to form the white light.

The external electrode 300 is positioned on the lamp body 200. Alternatively, a plurality of external electrodes 300 may be included on the lamp body 200. In this exemplary embodiment, the external electrode 300 is on a peripheral edge portion of the bottom portion 201 adjacent to the side portions 202 and 203.

Alternatively, the external electrodes 300 may be on the bottom portion 201 and the light emitting portion 206 adjacent to the side portions 202 and 203, and the external electrodes 300 may be similarly constructed.

A discharge voltage is applied to the external electrode 300 so that the discharge voltage is applied to the lamp body 200, thereby generating a plasma in the discharge space 205. Invisible light is generated by the plasma. Alternatively, two external electrodes 300 may be positioned on the lamp body 110.

External electrode 300 includes a metal layer 301 and a protection layer 303 on the metal layer 301 to protect the metal layer 301. The protection layer 303 also electrically insulates the metal layer 301 from a conductive element such as a metal frame, a metal chassis, etc. That is, the protection layer 303 may be an insulating protection layer.

The metal layer 301 is positioned on the peripheral portion of the bottom portion 201 of the lamp body 200. In this exemplary embodiment, the metal layer 301 is rectangular in cross-section. Metal layer 301 is comprised of an electrically and thermally conductive material. Examples of suitable electrically and thermally conductive material that can be used for the metal layer 301 include aluminum, copper, chromium, nickel, gold, silver, an alloy thereof, a combinations thereof.

The protection layer 303 covers a lower surface of metal layer 301. The protection layer 303 is comprised of an electrically insulating material to prevent an electrical contact between the metal layer 301 and a metal structure on which lamp body may be placed.

Protection layer 303 also provides protection of metal layer 301 from a chemical impurity such as oxygen and moisture, which can oxidize metal layer 301.

In this exemplary embodiment, the protection layer 303 has a thickness of about 10 μm to about 100 μm. When the protection layer 303 has a thickness of less than about 10 μm, a portion of metal layer 301 may be exposed through an opening of the protection layer 303. When the protection layer 303 has a thickness of more than about 100 μm, the protection layer 303 may become separated from metal layer 301.

The protection layer 303 may comprise a metal oxide. The metal oxide may be formed by oxidation of the metal layer 301. Examples of an oxidation process of the metal layer 301 that can be used to form the protection layer 303 include an anodizing oxidation process and a plasma oxidation process.

The protection layer 303 may be comprised of a crystalline material. Examples of the crystalline material that can be used for the protection layer 303 include aluminum oxide, copper oxide, chromium oxide, nickel oxide, gold oxide, silver oxide and a combination thereof. The protection layer 303 of a crystalline material more strongly adheres to metal layer 301 than does protection layer 303 comprised of an amorphous material.

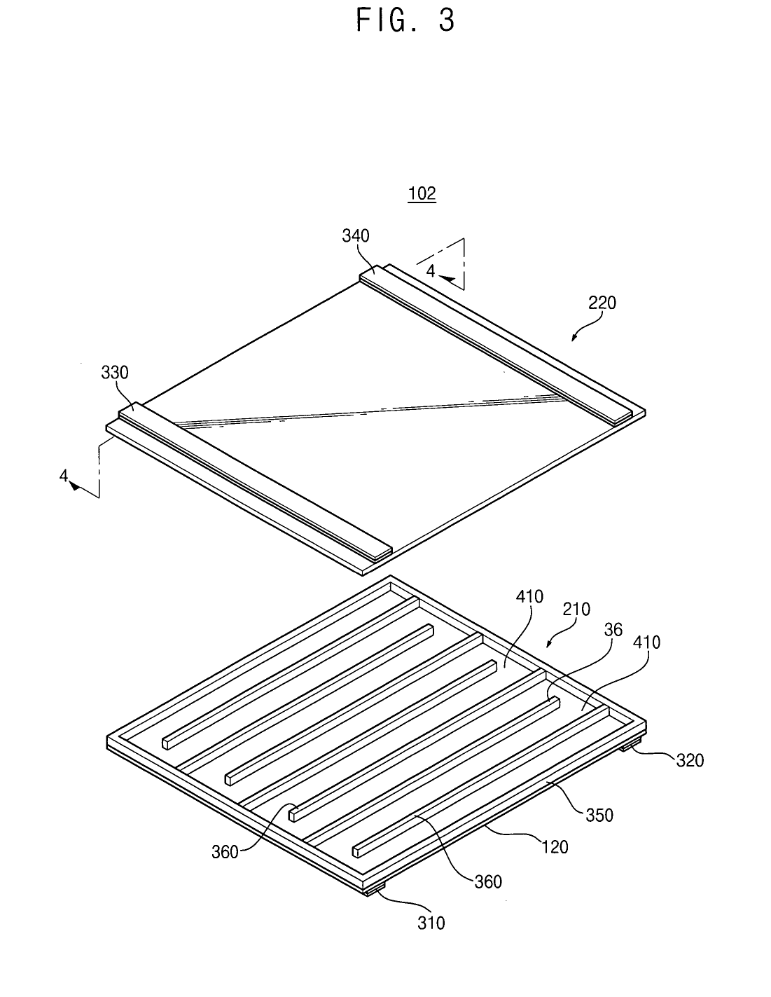

FIG. 2 is a cross-sectional view showing a light generating unit in accordance with another exemplary embodiment of the present invention. The light generating unit of FIG. 2 is same as in FIG. 1 except for the addition of a fluorescent layer and an adhesive member. Thus, the same reference numerals will be used to refer to the same or like parts as those described in FIG. 1 and any further explanation concerning the above elements will be omitted.

Referring to FIG. 2, the fluorescent layer 420 includes a first fluorescent portion 421 and a second fluorescent portion 422. The first fluorescent portion 421 is positioned on an upper surface of a bottom portion 201, and the second fluorescent portion 422 is positioned on a lower surface of a light emitting portion 206. The first and second fluorescent portions 421 and 422 may be constructed of the same material.

An adhesive member 380 is interposed between a lamp body 200 and external electrode 300 so that the lamp body 200 is secured to external electrode 300. Adhesive member 380 may be constructed using a binder that includes conductive particles, the lamp body 200 and the external electrode 300. In this exemplary embodiment, the adhesive member 380 includes a silver paste.

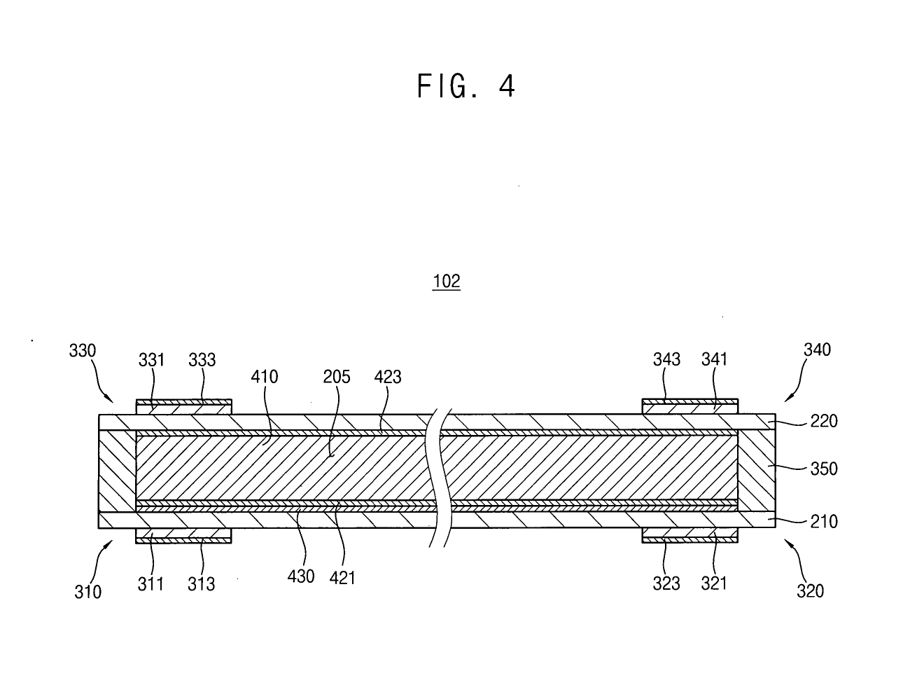

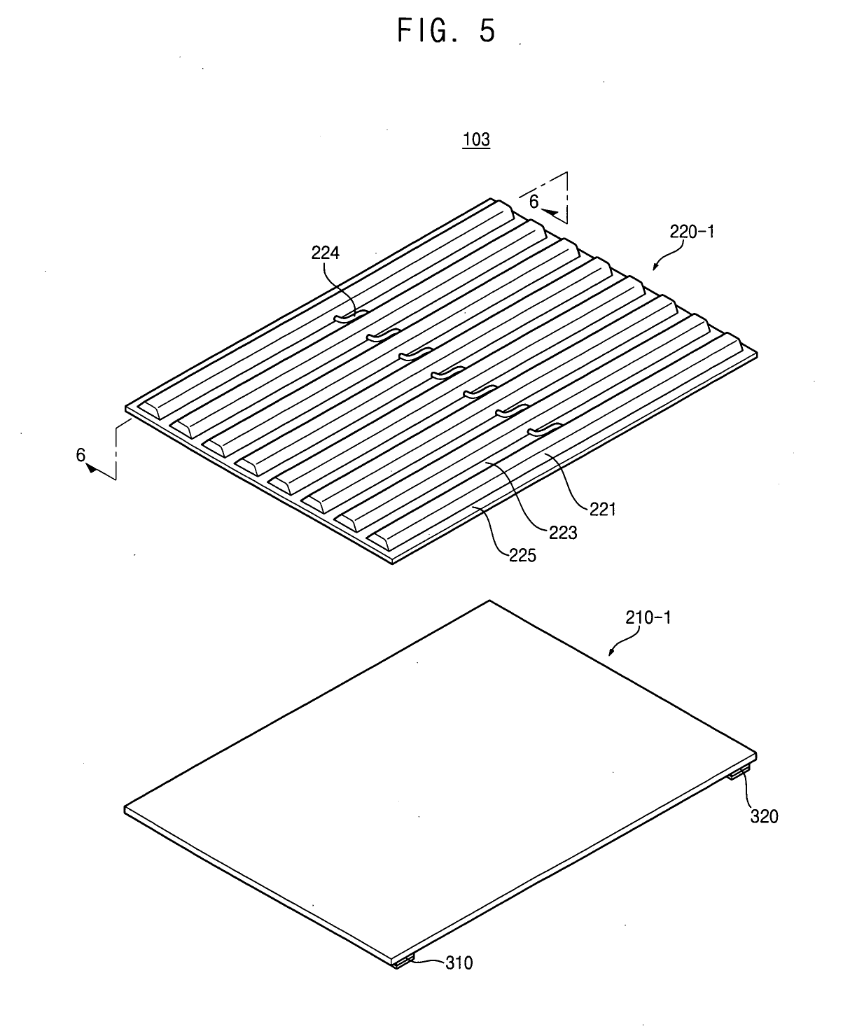

FIG. 3 is an exploded perspective view showing a light generating unit in accordance with another exemplary embodiment of the present invention. FIG. 4 is a cross-sectional view taken along a line 4-4 shown in FIG. 3.

Referring to FIGS. 3 and 4, the light generating unit 102 includes a first substrate 210, a second substrate 220, a first external electrode 310 which is comprised of layers 311 and 313, a second external electrode 320 which is comprised of layers 321 and 323, a third electrode 330 which is comprised of layers 331 and 333; and a fourth electrode 340 comprised of layers 341 and 343.

The first substrate 210 has a quadrangular plate shape, and transmits a visible light. In this exemplary embodiment, the first substrate 210 is comprised of glass, and blocks ultraviolet light.

The second substrate 220 may be constructed like first substrate 210. In this exemplary embodiment, the second substrate 220 has substantially the same shape as the first substrate 210. The second substrate 220 has the quadrangular plate shape, and is comprised of glass. The second substrate 220 blocks ultraviolet light.

The light generating unit 102 further includes a sealing member 350 and at least one partition wall 360. The sealing member 350 is interposed between peripheral portions of the first and second substrates 210 and 220 to form an internal space. The partition wall 360 is interposed between the first and second substrates 210 and 220 to divide the internal space into a plurality of discharge spaces 410 which are clearly shown in FIG. 4.

The sealing member 350 is comprised of glass and is substantially same material as the first and second substrates 210 and 220. In this exemplary embodiment, sealing member 350 includes a frit which is a mixture of the glass and a metal. The frit has a lower melting point than a pure glass.

Partition walls 360 have an elongated rod shape. In this exemplary embodiment, a plurality of partition walls 360 are spaced apart from one another by a constant distance. Partition walls 360 includes the glass, and partition walls 360 are secured to first and second substrates 220 using a frit. Alternatively, the partition wall 360 may be formed by a dispenser.

One end portion of the partition walls 360 is spaced apart from the sealing member 350 so that pressure within the plurality of discharge spaces 205 are uniform. In this exemplary embodiment, the partition walls 360 are arranged in a serpentine shape. That is, the one end portion of the partition wall 360 is spaced apart from the sealing member 350, and another end portion of the partition wall 360 makes contact with the sealing member 350.

Alternatively, both end portions of the partition walls 360 may make contact with the sealing member 350, and a connecting hole (not shown) may be formed through partition wall 360 to connect adjacent discharge spaces 205.

The light generating unit 102 further includes a reflecting layer 420 positioned on an upper surface of the first substrate 210, a first fluorescent layer 421 positioned on the reflecting layer 420 and a second fluorescent layer 423 positioned on a lower surface of the second substrate 220.

Visible light generated from the first and second substrates 210 and 220 is reflected from the reflecting layer 430 to prevent light leakage from the first substrate 210. The reflecting layer 430 includes a metal oxide to increase its reflectivity and to prevent a variation of color coordinates. Examples of the suitable metal oxides that can be used to form the reflecting layer 430 include aluminum oxide and barium sulfate.

When ultraviolet light that is generated by a plasma discharge is irradiated onto the first and second fluorescent portions 421 and 423, visible light is generated from the first and second fluorescent portions 421 and 423. Alternatively, the first fluorescent 421 may be positioned on inner surfaces of the partition walls 360.

The first, second, third and fourth external electrodes 310, 320, 330 and 340 are arranged substantially in perpendicular to a longitudinal direction of the partition walls 360 so that the first, second, third and fourth external electrodes 310, 320, 330 and 340 cross the discharge spaces 205. The first external electrode 310 is on a lower surface of the first substrate 210 corresponding to a side of the first substrate 210. The second external electrode 320 is on the lower surface of the first substrate 210 corresponding to another side of the first substrate 210, and corresponds to the first external electrode 310. The third external electrode 330 is on an upper surface of the second substrate 220 corresponding to the first external electrode 310. The fourth external electrode 340 is on the upper surface of the second substrate 220 corresponding to the second external electrode 310.

The first external electrode 310 includes a first metal layer 311 and a first protection layer 313 that is positioned on the first metal layer 311 to protect the first metal layer 311. The second external electrode 320 includes a second metal layer 321 and a second protection layer 323 that is positioned on the second metal layer 321 to protect the second metal layer 321. The third external electrode 330 includes a third metal layer 331 and a third protection layer 333 that is on the third metal layer 331 to protect the third metal layer 331. The fourth external electrode 340 includes a fourth metal layer 341 and a fourth protection layer 343 that is on the fourth metal layer 341 to protect the fourth metal layer 341. Each of the first, second, third and fourth external electrodes 310, 320, 330 and 340 is constructed like the electrodes shown in FIG. 1. Thus further explanation concerning them is not required.

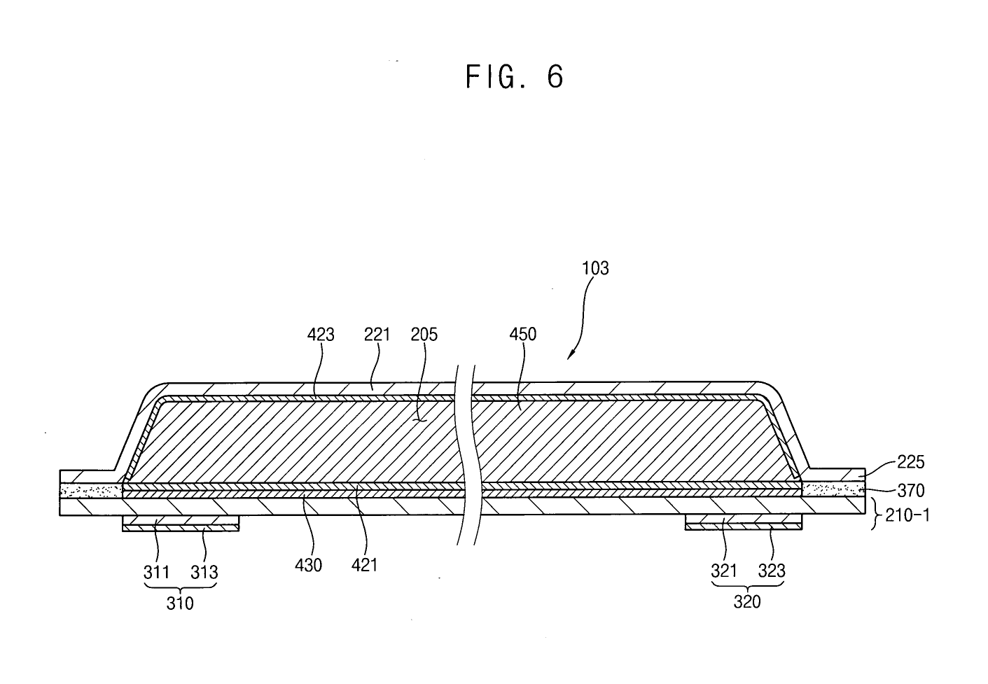

FIG. 5 is an exploded perspective view showing a light generating unit in accordance with another exemplary embodiment of the present invention. FIG. 6 is a cross-sectional view taken along a line 6-6 shown in FIG. 5 with the unit as assembled.

Referring to FIGS. 5 and 6, the light generating unit 103 includes a first substrate 210-1, a second substrate 220-1, a first external electrode 310 and a second external electrode 320. The second substrate 220-1 is combined with the first substrate 210-1 to form a plurality of discharge spaces 205.

In this exemplary embodiment, the first substrate 210-1 has a quadrangular plate shape, and transmits a visible light. The first substrate 210-1 may include glass.

The second substrate 220-1 has a plurality of discharge space portions 221, a plurality of space dividing portions 223 and a sealing portion 225. The discharge space portions 221 are spaced apart from the first substrate 210-1 to form the discharge spaces 205. The space dividing portions 223 make contact with the first substrate 210-1 between the discharge space portions 221 adjacent to each other. The sealing portion 225 is between peripheral portions of the first and second substrates 210-1 and 220-1, respectively. The second substrate 220-1 includes a transparent material that transmits the visible light. Examples of transparent material that can be used for the second substrate 220 include glass and polycarbonate.

The second substrate 220-1 is formed through a molding process. That is, a glass plate is heated and pressed to form the second substrate 220-1 having the discharge space portions 221, the space dividing portions 223 and the sealing portion 225.

Alternatively, the second substrate 220-1 may be formed through a blow molding process. In the blow molding process, the glass plate is heated and compressed by an air to form the second substrate 220-1.

A cross-section of the second substrate 220-1 includes a plurality of trapezoidal shapes that are connected to one another. The trapezoidal shapes have rounded corners, and are arranged substantially in parallel. Alternatively, the cross-section of the second substrate 220-1 may have a semicircular shape, a quadrangular shape, or a polygonal shape.

A connecting passages 224 are formed on the second substrate 220 to connect the discharge spaces 205 adjacent to each other. In this exemplary embodiment, at least one connecting passage 224 is formed on each of the space dividing portions 223. Each of the connecting passages 224 is spaced apart from the first substrate 210 by a predetermined distance. The connecting passages 224 may be formed through the molding process for forming the second substrate 220. The discharge gas that is injected into one of the discharge spaces 205 may pass through each of the connecting passages 224 so that pressure in each of the discharge spaces 205 is substantially equal. Each of the connecting passages 224 may have various shapes such as ‘S’ shape.

An adhesive 370 such as a frit is interposed between the first and second substrates 210-1 and 220-1 to combine the first substrate 210-1 with the second substrate 220-1. The frit is a mixture of glass and metal, and a melting point of the frit is lower than pure glass. That is, the adhesive 370 is positioned on the sealing portion 225 of the first and second substrates 210-1 and 220-1, and the adhesive 370 is fired and solidified.

The space dividing portions 223 of the second substrate 220 are combined with the first substrate 210 by a pressure difference between the discharge spaces 205 and outside of the flat fluorescent lamp 103. In particular, the first substrate 210-1 is combined with the second substrate 220-1, and air between the first and second substrates 210-1 and 220-1 is discharged so that the discharge spaces 205 are evacuated. A discharge gas is injected into the evacuated discharge spaces 205. In this exemplary embodiment, a pressure of the discharge gas in the discharge spaces 205 is about 50 Torr to about 70 Torr, and an atmospheric pressure of outside of the flat fluorescent lamp 103 is about 760 Torr, thereby forming the pressure difference. Therefore, the space dividing portions 223 are combined with the first substrate 210.

The first and second external electrodes 310 and 320 are on a lower surface of the first substrate 210, and extended in a direction substantially in perpendicular to a longitudinal direction of the space dividing portions 223 so that each of the first and second external electrodes 310 and 320 crosses the discharge spaces 205. Each of the first and second external electrodes 310 and 320 is same as in FIG. 1. Accordingly, further explanation concerning these electrodes is not required.

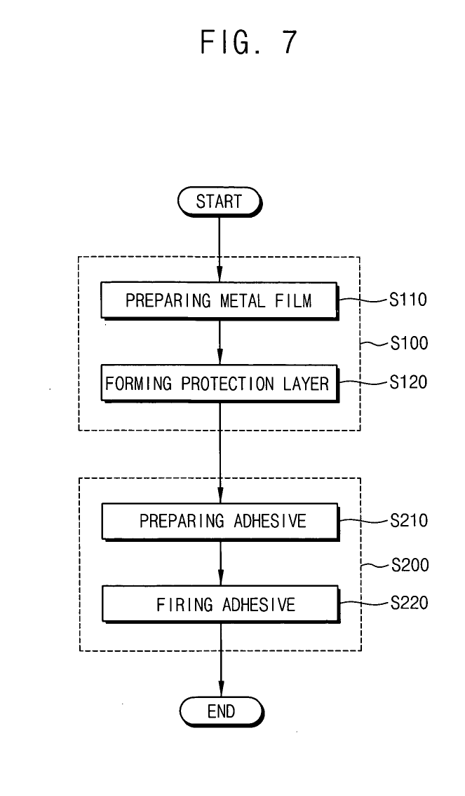

FIG. 7 is a flow chart showing a method of manufacturing a light generating unit in accordance with an exemplary embodiment of the present invention.

Referring to FIG. 7, a conductive member is prepared (step S100). The conductive member includes a metal layer and a protection layer on the metal layer.

In order to prepare the conductive member, a metal layer is prepared (step S110). In this exemplary embodiment, the metal layer has a band shape, and includes aluminum or aluminum alloy. The protection layer is formed on the metal layer (step S120). The protection layer electrically insulates the metal layer from a conductive element, and prevents an oxidation of the metal layer.

In this exemplary embodiment, the protection layer is formed through an anodizing process. In the anodizing process, a metal layer is exposed to an electrolyte that includes phosphoric acid, sulfuric acid, or oxalic acid. A direct current voltage of about 200V is applied to the metal layer which is an anode and an inert metal electrode that is a cathode for about one hour so that a portion of the metal layer is oxidized to form a metal oxide layer. The amount of the metal oxide layer is increased as a time period of the oxidization is increased. In particular, when the aluminum is oxidized through the anodizing process at a temperature of about 15° C. and a direct current voltage of about 40V under about 0.3 M oxalic acid. A thickness of an aluminum oxide layer is increased at the rate of about 1 μm/10 min. The protection layer formed through this anodizing process has a porous amorphous structure.

Alternatively, the protection layer may be formed through a plasma oxidization process. In the plasma oxidization process, a voltage is applied to a metal layer that is an anode and a cathode that is spaced apart from the metal layer under an oxygen plasma atmosphere so that a portion of the metal layer is oxidized. The oxygen plasma is formed at a temperature of about 300° C. to about 500° C. under a pressure of about 1 Torr in a radio frequency of about 10 MHz.

The protection layer formed through the plasma oxidization process has a crystalline material. Examples of the crystalline material that can be used for the protection layer may include aluminum oxide, copper oxide, chromium oxide, nickel oxide, gold oxide, silver oxide, a combination thereof, etc. The protection layer having the crystalline material has stronger mechanical strength than the protection layer having the amorphous material.

The conductive member having the metal layer and the protection layer is combined with a lamp body that has a discharge space to generate a light (step S200).

In order to combine the conductive member with the lamp body, an adhesive is interposed between the conductive member and the lamp body (step S210). In this exemplary embodiment, the conductive member includes a plurality of conductive particles, a binder that binds the lamp body to the conductive member, and a solvent. The adhesive may be a silver paste.

The adhesive is then fired so that the adhesive is solidified (step S220). Therefore, the lamp body is combined with the conductive member to form the external electrode on an outer surface of the lamp body.

Alternatively, an electrode having a multi layered structure of a metal layer and a protection layer on the metal layer may be attached to the lamp body.

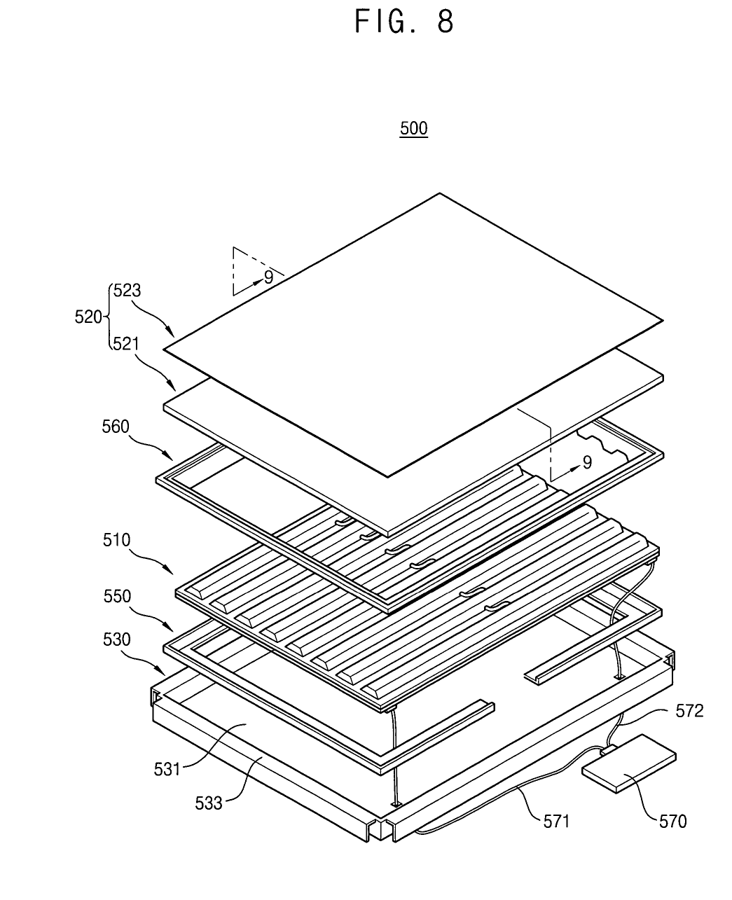

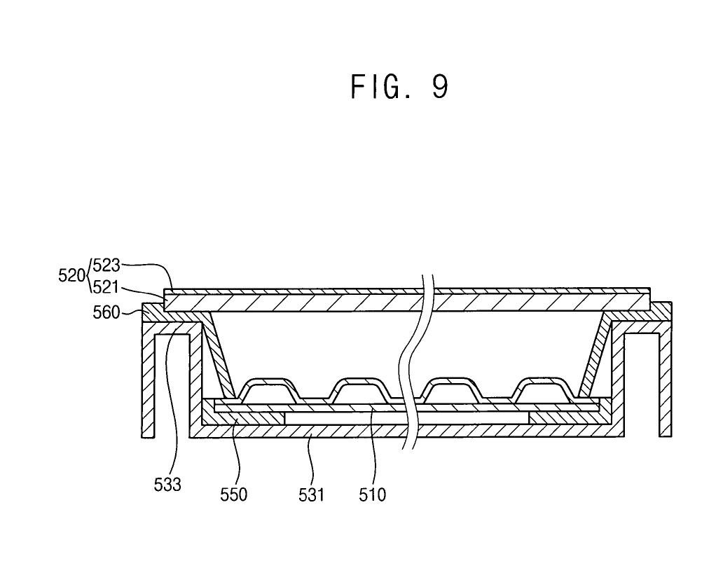

FIG. 8 is an exploded perspective view showing a backlight assembly in accordance with an exemplary embodiment of the present invention. FIG. 9 is a cross-sectional view taken along line 9-9 of FIG. 8 showing the backlight assembly shown in FIG. 8 in an assembled condition.

Referring to FIGS. 8 and 9, the backlight assembly 500 includes a light generating unit 510, an optical member 520 and a receiving container 530. The light generating unit 510 generates light. The optical member 520 improves optical characteristics of the light generated from the light generating unit 510. The receiving container 530 receives the light generating unit 520 and the optical member 520.

The receiving container 530 includes a bottom plate 531 and a plurality of sidewalls 533 that are protruded from sides of the bottom plate 531. In this exemplary embodiment, each of the sidewalls 533 is bent twice to form a combining space for combining the sidewalls 533 with other elements such as a top chassis, a mold frame, etc. The receiving container 530 includes a strong metal that has an impact resistance.

The light generating unit 510 is in a receiving space of the receiving container 530. The light generating unit 510 may be the same as light generating unit 103 shown in FIGS. 5 and 6. Thus further explanation concerning the above element is not required.

The optical sheet 520 includes a diffusion plate 521 and a brightness enhancement sheet 523. The diffusion plate 521 diffuses the light. The brightness enhancement sheet 523 increases a luminance when viewed in a plane.

The diffusion plate 521 is on the light generating unit 510, and spaced apart from the light generating unit 510. The diffusion plate 521 diffuses the light so that the luminance of the light is uniformized. The diffusion plate 521 has a plate shape of a predetermined thickness. In this exemplary embodiment, the diffusion plate 521 includes polymethyl-methacrylate.

The brightness enhancement sheet 523 guides the light toward a front of the backlight assembly 500 so that the luminance when viewed in the plane is increased. Alternatively, the backlight assembly 500 may further include additional optical sheet (not shown).

The backlight assembly 500 includes an inverter 570, a cushioning member 550 and a first mold 560. The inverter 570 generates a discharge voltage to drive the light generating unit 510. The cushioning member 550 absorbs an externally provided impact to protect the light generating unit 510. The first mold 560 supports the cushioning member 550 and the optical member 520.

The inverter 570 is on a rear surface of the receiving container 530. The inverter 570 generates the discharge voltage to drive the light generating unit 510. The inverter 570 elevates a level of a voltage that is provided to inverter 570 from an external voltage source to drive the light generating unit 510. The discharge voltage is applied to external electrode through a first power supply line 571 and a second power supply line 572.

The cushioning member 550 is interposed between the light generating unit 510 and the bottom plate 531 of the receiving container 530 to support the light generating unit 510. The cushioning member 550 has an elasticity to absorb the externally provided impact. In this exemplary embodiment, the cushioning member 550 is adjacent to the light generating unit 510.

The first mold 560 fixes the light generating unit 510 to the receiving container 530, and supports the optical member 520. The first mold 560 is combined with the sidewall 533 of the receiving container 530, and presses peripheral portions of the light generating unit 510 to fix the light generating unit 510 to the receiving container 530. The first mold 560 may have a frame shape.

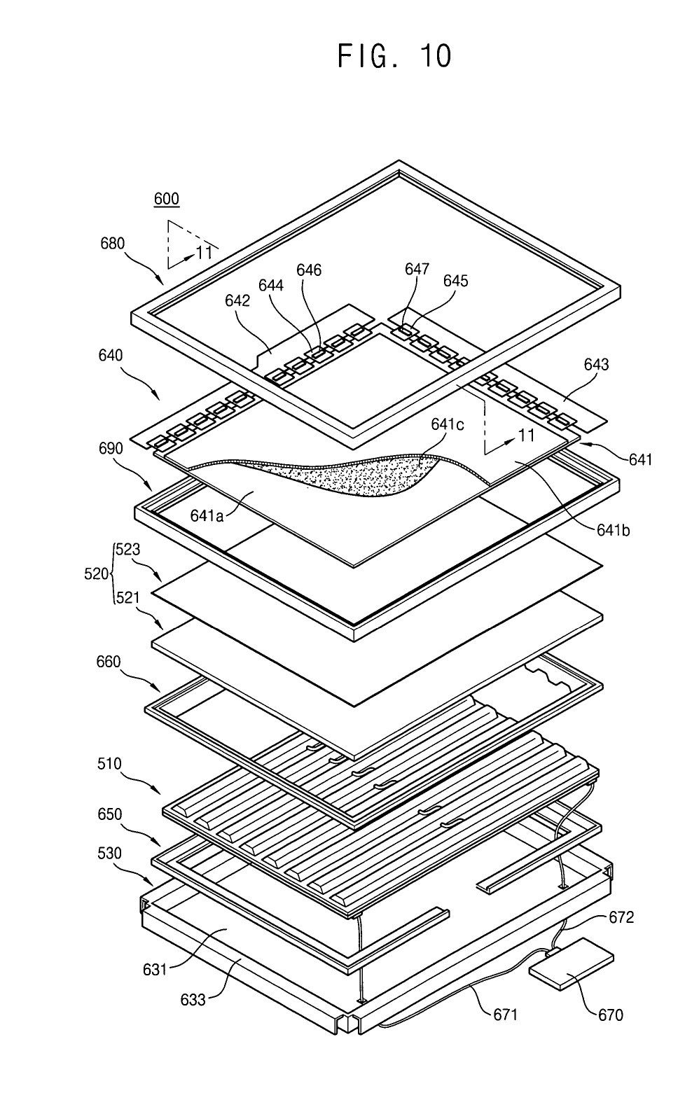

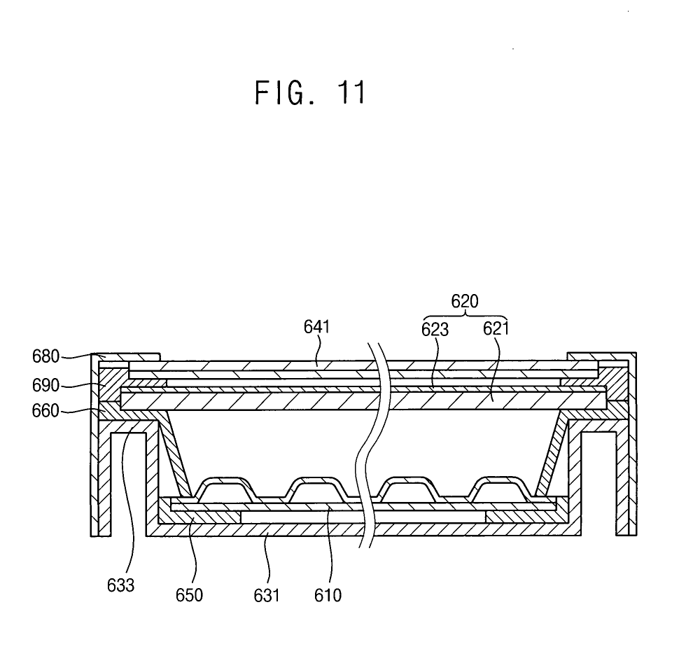

FIG. 10 is an exploded perspective view showing a display device in accordance with an exemplary embodiment of the present invention. FIG. 11 is a cross-sectional view taken along line 11-11 in FIG. 10 showing the display device shown in FIG. 10 in an assembled condition.

Referring to FIGS. 10 and 11, the display device 600 includes a light generating unit 510, an optical member 520, a receiving container 530 and a display unit 640, all of which have been describe above. The light generating unit 510 generates a light. The optical member 520 improves optical characteristics of the light generated from the light generating unit 510. The receiving container 530 receives the light generating unit 510 and the optical member 510. The display unit 640 displays an image using the light.

The display unit 640 includes a liquid crystal display (LCD) panel 641, a data printed circuit board (PCB) 642 and a gate PCB 643. The LCD panel 641 displays the image using the light generated from the light generating unit 510. The data PCB 642 and the gate PCB 643 apply driving signals to the LCD panel 641.

The driving signals from the data PCB 642 and the gate PCB 643 are applied to the LCD panel 641 through a data flexible circuit film 644 and a gate flexible circuit film 645, respectively.

Each of the data flexible circuit film 644 and the gate flexible circuit film 645 may be a tape carrier package (TCP) or a chip on film (COF). The data flexible circuit film 644 and the gate flexible circuit film 645 include a data driving chip 646 and a gate driving chip 647, respectively, to control the driving signals.

The data flexible circuit film 644 is backwardly bent so that the data PCB 644 is on a side surface or a rear surface of the receiving container 630. The gate flexible circuit film 645 is backwardly bent so that the gate PCB 643 is on the side surface or the rear surface of the receiving container 630.

The LCD panel 641 includes a thin film transistor (TFT) substrate 641a, a color filter substrate 641b and a liquid crystal layer 641c. The color filter substrate 641b corresponds to the TFT substrate 641a. The liquid crystal layer 641c is interposed between the TFT substrate 641a and the color filter substrate 641b.

The TFT substrate 641a is comprised of a transparent glass substrate and a plurality of TFTs (not shown) that are arranged in a matrix shape on the transparent glass substrate. A data line is electrically connected to a source electrode of each of the TFTs. A gate line is electrically connected to a gate electrode of each of the TFTs. A pixel electrode (not shown) is electrically connected to a drain electrode of each of the TFTs.

The color filter substrate 641b includes a transparent substrate having a color filter (not shown) that is formed through a thin film process, and a common electrode (not shown) having a transparent conductive material.

When a voltage is applied to the gate electrode of each of the TFTs so that the TFT is turned on, an electric field is formed between the pixel electrode and the common electrode. The orientation of liquid crystals of the liquid crystal layer 641c is determined in response to the electric field applied thereto so that a light transmittance of the liquid crystal layer 641c is changed, thereby displaying the image.

The LCD device 600 further includes a first frame member 660, a second frame member 690 and a top chassis 680. First frame member 660 is interposed between the light generating unit 510 and the optical member 520 to fix the light generating unit 510 to the receiving container 530. Second frame member 690 is interposed between the optical member and the LCD panel 641.

The second frame member 690 fixes the optical member 520 to the first frame member 660, and supports the LCD panel 641. In this exemplary embodiment, the second frame member 690 has a frame shape.

The top chassis 680 surrounds peripheral portions of the LCD panel 641. The top chassis 680 is combined with the receiving container 630 to fix the LCD panel 641 to the second frame member 690. The top chassis 680 protects the LCD panel 641 from an externally provided impact, and prevents a drifting of the LCD panel 641.

According to the present invention, the protection layer protects the metal layer to prevent an oxidation of the metal layer and a formation of ozone. In addition, the metal layer is electrically insulated from adjacent conductive element.

In addition, the electrode having the multi-layered structure of the metal layer and the protection layer on the metal layer may be attached to the lamp body so that a manufacturing process of the light generating unit is simplified.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A light generating unit comprising:
a lamp body including a discharge space to generate light; and
an external electrode positioned on the lamp body, the external electrode including a metal layer and a protection layer positioned on the metal layer.

2. The light generating unit of claim 1, wherein the protection layer comprises a crystalline material.

3. The light generating unit of claim 1, wherein the protection layer comprises a metal oxide layer.

4. The light generating unit of claim 1, wherein a thickness of the protection layer is from about 10 μm to about 100 μm.

5. The light generating unit of claim 1, wherein the metal layer comprises at least one material selected from the group consisting of aluminum, copper, nickel, chromium, gold, silver and an alloy thereof.

6. The light generating unit of claim 1, further comprising an adhesive interposed between the lamp body and the external electrode to attach the external electrode to the lamp body.

7. The light generating unit of claim 1, wherein the lamp body comprises:
a discharge gas in the discharge space; and
a fluorescent layer of material on an inner surface of the lamp body.

8. The light generating unit of claim 1, wherein the lamp body comprises:
a first substrate; and
a second substrate combined with the first substrate to form a plurality of discharge spaces.

9. The light generating unit of claim 8, wherein the second substrate comprises:
a plurality of discharge space portions spaced apart from the first substrate;
a plurality of space dividing portions in contact with the first substrate between the discharge space portions adjacent to each other; and
a sealing portion on a peripheral portion of the second substrate.

10. The light generating unit of claim 9, wherein the external electrode extends in a direction substantially perpendicular to a longitudinal direction of the space dividing portions.

11. The light generating unit of claim 8, further comprising:
a sealing member interposed between peripheral portions of the first and second substrates to form an internal space; and
at least one partition wall between the first and second substrates to divide the internal space into a plurality of discharge spaces.

12. The light generating unit of claim 11, wherein the external electrode extends in a direction substantially perpendicular to a longitudinal direction of the partition wall.

13. A method of manufacturing a light generating unit comprising:
preparing a conductive member having a metal layer and a protection layer on the metal layer; and
combining the conductive member with a lamp body which includes a discharge space to generate a light.

14. The method of claim 13, wherein the protection layer is prepared using an anodizing process.

15. The method of claim 13, wherein the protection layer is prepared using a plasma oxidization process.

16. The method of claim 13, wherein the conductive member is combined with the lamp body by:
interposing an adhesive between the conductive member and the lamp body; and
firing the adhesive interposed between the conductive member and the lamp body.

17. The method of claim 16, wherein the adhesive comprises conductive particles, a binder and a solvent.

18. A backlight assembly comprising:
a light generating unit including:
a lamp body including a discharge space to generate light; and
an external electrode positioned on the lamp body, the external electrode including a metal layer and a protection layer positioned on the metal layer;
an optical member; and
a receiving container that receives the light generating unit and the optical member.

19. The backlight assembly of claim 18, further comprising an inverter coupled to the light generating unit.

20. The backlight assembly of claim 18, wherein the protection layer comprises a crystalline material.

21. The backlight assembly of claim 18, wherein the protection layer comprises a metal oxide layer.

22. The backlight assembly of claim 18, wherein a thickness of the protection layer is about 10 μm to about 100 μm.

23. The backlight assembly of claim 18, wherein the metal layer comprises at least one selected from the group consisting of aluminum, copper, chromium, gold, silver and an alloy thereof.

24. A display device comprising:
a light generating unit including:
a lamp body including a discharge space to generate light; and
an external electrode positioned on the lamp body, the external electrode including a metal layer and a protection layer positioned on the metal layer;
an optical member; and
a receiving container that receives the light generating unit and the optical member.
